(19) United States
(12) Patent Application Publication
(10) Pub. No.: US 2005/0280347 A1
(43) Pub. Date: Dec. 22, 2005

(54) Flat lamp

(75) Inventors: Sang-hun Jang, Gyeonggi-do (KR); Hyoung-bin Park, Gyeonggi-do (KR); Young-mo Kim, Gyeonggi-do (KR); Seong-eui Lee, Gyeonggi-do (KR); Seung-hyun Son, Gyeonggi-do (KR); Gi-young Kim, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Gyeonggi-do (KR)

(21) Appl. No.: 11/071,365

(22) Filed: Mar. 4, 2005

(30) Foreign Application Priority Data
Jun. 17, 2004 (KR) 10-2004-0045048

(51) Int. Cl. H01J 1/62

(52) U.S. Cl. 313/492

(57) ABSTRACT

Provided is a flat lamp which includes a lower substrate and an upper substrate arranged to face each other and forming a discharge space between the lower substrate and the upper substrate, a plurality of discharge electrodes formed at at least one of the lower substrate and the upper substrate, a plurality of spacers provided between the lower substrate and the upper substrate to maintain a uniform gap between the lower substrate and the upper substrate, at least one auxiliary electrode provided in each of the spacers, in which a voltage is induced as a voltage is applied to the discharge electrodes, and a fluorescent layer formed on an interior of the discharge space.

### BACKGROUND OF THE INVENTION

Priority is claimed to Korean Patent Application No. 10-2004-0045048, filed on Jun. 17, 2004, in the Korean Intellectual Property Office, the disclosure of which is incorporated herein in its entirety by reference.

1. Field of the Invention

The present invention relates to a flat lamp, and more particularly, to a flat lamp that reduces a discharge voltage and improves a luminous efficiency.

2. Description of the Related Art

Flat lamps which are used as backlights for liquid crystal displays (LCDs) have been developed from edge-light type or direct-light type flat lamps using cold cathode fluorescent lamps, to surface discharge type or facing discharge type flat lamps in which the whole lower portion of a light emitting panel is used as a discharge space considering a luminous efficiency and uniformity in brightness. Typically, the surface discharge type flat lamp is superior to the facing discharge type flat lamp in a stable discharge property, but is inferior to the facing discharge type flat lamp in the overall brightness.

FIG. 1 shows an example of a conventional surface discharge type flat lamp. Referring to FIG. 1, a lower substrate 10 and an upper substrate 20 are separated a predetermined distance from each other by a plurality of spacers 14, so as to face each other. A discharge space where plasma discharge is generated is formed between the lower substrate 10 and the upper substrate 20. The discharge space is filled with a discharge gas that is usually a mixture of neon (Ne) gas and xenon (Xe) gas.

A fluorescent layer 13 to generate visible light by being excited by ultraviolet rays generated by discharge is formed on inner surfaces of the lower and upper substrates 10 and 20 and both side surfaces of the spacers 14. A plurality of discharge electrodes for generating plasma discharge is formed on the lower and upper substrates 10 and 20. In detail, first and second lower electrodes 12a and 12b, and first and second upper electrodes 22a and 22b, are formed in pairs on outer surfaces of the lower and upper substrates 10 and 20. Since the same electric potential is applied between the first lower electrode 12a and the first upper electrode 22a, no discharge is generated therebetween. Likewise, since the same electric potential is applied between the second lower electrode 12b and the second upper electrode 22b, no discharge is generated therebetween as well. Meanwhile, since predetermined potential differences exist between the first lower electrode 12a and the second lower electrode 12b, and the first upper electrode 22a and the second upper electrode 22b, surface discharges are generated therebetween in a direction parallel to the lower substrate 10 and the upper substrate 20.

In the flat lamp configured as above, however, when the distance between the discharge electrodes, or the partial pressure of the xenon gas or the pressure of the discharge gas, is increased to improve a luminous efficiency, the discharge voltage increases accordingly.

### SUMMARY OF THE INVENTION

To solve the above and/or other problems, the present invention provides a flat lamp that can reduce a discharge voltage and improve a luminous efficiency.

According to an aspect of the present invention, a flat lamp comprises a lower substrate and an upper substrate arranged to face each other and forming a discharge space between the lower substrate and the upper substrate, a plurality of discharge electrodes formed at at least one of the lower substrate and the upper substrate, a plurality of spacers provided between the lower substrate and the upper substrate to maintain a uniform gap between the lower substrate and the upper substrate, at least one auxiliary electrode provided in each of the spacers, in which a voltage is induced as a voltage is applied to the discharge electrodes, and a fluorescent layer formed on an interior of the discharge space.

The discharge electrodes can be formed on an outer surface of at least one of the lower substrate and the upper substrate.

The spacers can be provided in a direction perpendicular to the discharge electrodes. The spacers have rectangular or circular sections for example and can be formed of a dielectric material or a transparent glass material, for example.

Two auxiliary electrodes can be provided in each of the spacers in a lengthwise direction of the spacers to be separated from each other in a horizontal or vertical direction.

The auxiliary electrode can be formed of metal or at least one selected from a group consisting of silver (Ag), copper (Cu), and chrome (Cr).

A plurality of auxiliary spacers can be provided between the lower substrate and the upper substrate in a direction perpendicular to the spacers. The height of the auxiliary spacers can be less than that of the spacers. The fluorescent layer can be formed on an exterior of each of the auxiliary spacers.

The discharge space is filled with a discharge gas, which can be a mixture of neon (Ne) gas and xenon (Xe) gas.

According to another aspect of the present invention, a flat lamp comprises a lower substrate and an upper substrate arranged to face each other and forming a discharge space between the lower substrate and the upper substrate, a plurality of discharge electrodes formed at least one of the lower substrate and the upper substrate, a plurality of spacers provided between the lower substrate and the upper substrate to maintain a uniform gap between the lower substrate and the upper substrate, a plurality of auxiliary electrodes provided formed at least one of the lower substrate and the upper substrate, in which a voltage is induced as a voltage is applied to the discharge electrodes, and a fluorescent layer formed on an interior of the discharge space.

The auxiliary electrodes can be formed in a direction perpendicular to the discharge electrodes on an inner surface of at least one of the lower substrate and the upper substrate. A dielectric layer can be formed on an inner surface of at least one of the lower substrate and the upper substrate where the auxiliary electrodes are provided, to cover the auxiliary electrodes.

The auxiliary electrodes can be formed of a transparent conductive material, ITO (indium tin oxide), or at least one selected from a group consisting of silver (Ag), copper (Cu), and chrome (Cr).

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a portion of a conventional flat lamp;

FIG. 2 is an exploded perspective view illustrating a portion of a flat lamp according to an embodiment of the present invention;

FIG. 3 is a cross-sectional view of the flat lamp of FIG. 2;

FIG. 4 is a plan view of the flat lamp of FIG. 2;

FIG. 5 is an exploded perspective view illustrating a portion of a flat lamp according to another embodiment of the present invention;

FIG. 6 is a cross-sectional view illustrating a portion of a flat lamp according to another embodiment of the present invention;

FIG. 7 is a cross-sectional view illustrating a portion of a flat lamp according to another embodiment of the present invention;

FIG. 8 is a cross-sectional view illustrating a portion of a flat lamp according to another embodiment of the present invention;

FIG. 9 is an exploded perspective view illustrating a portion of a flat lamp according to another embodiment of the present invention;

FIG. 10 is a cross-sectional view of the flat lamp of FIG. 9;

FIG. 11 is a graph showing the result of comparison in the discharge voltage between the conventional flat lamp and an embodiment of the flat lamp according to the present invention;

FIG. 12 is a graph showing the result of comparison in the luminance between the conventional flat lamp and an embodiment of the flat lamp according to the present invention; and

FIG. 13 is a graph showing the result of comparison in the luminous efficiency between the conventional flat lamp and an embodiment of the flat lamp according to the present invention.

### DETAILED DESCRIPTION OF THE INVENTION

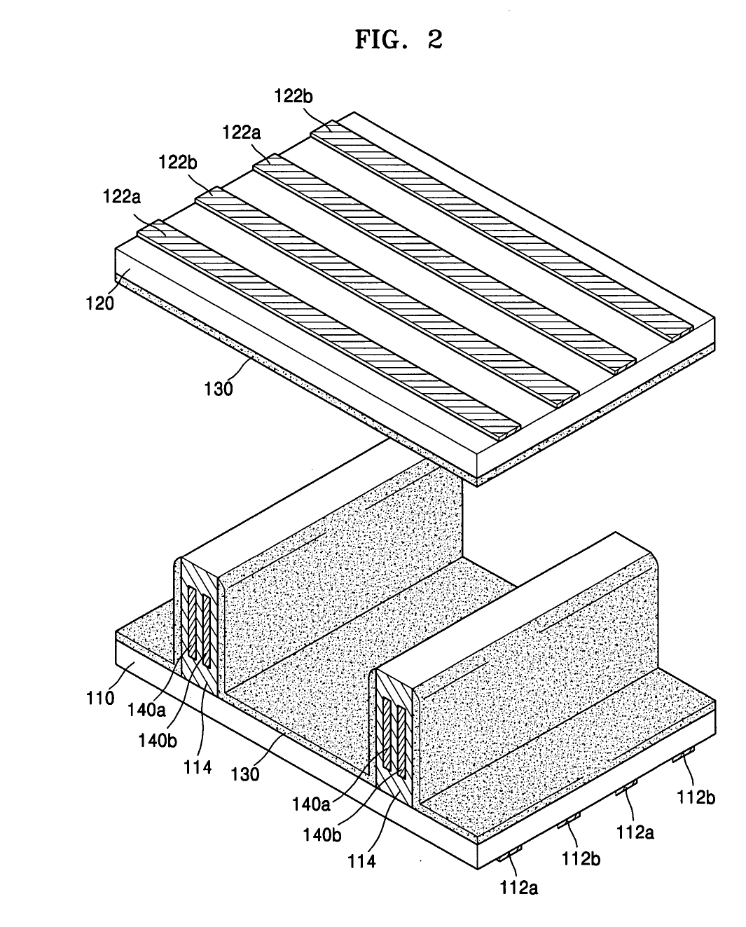

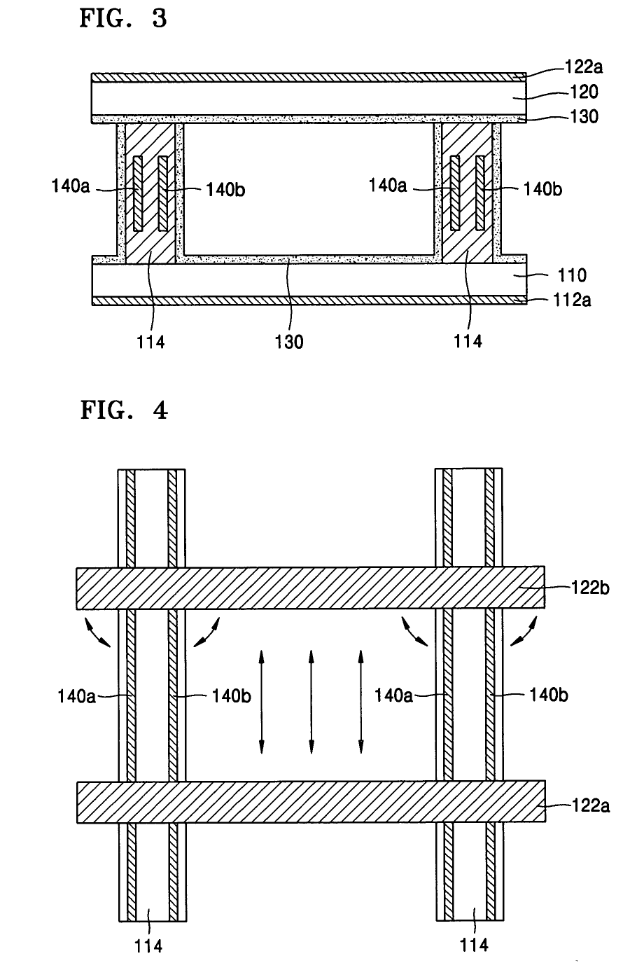

Referring to FIGS. 2 through 4, a lower substrate 110 and an upper substrate 120 are separated to face each other. A discharge space where plasma discharge is generated is formed between the lower and upper substrates 110 and 120. The discharge space is filled with a discharge gas that is a mixture of neon (Ne) gas and xenon (Xe) gas, for example.

First and second lower electrodes 112a and 112b, which are discharge electrodes, are formed on a lower surface of the lower substrate 110 in pairs and in strips oriented parallel to each other. When a predetermined voltage is applied between the first and second lower electrodes 112a and 112b, plasma discharge is generated in the discharge space. First and second upper electrodes 122a and 122b which are discharge electrodes are formed on an upper surface of the upper substrate 120 in pairs and in strips oriented parallel to each other. A predetermined voltage is applied between the first and second upper electrodes 122a and 122b to generate plasma discharge. In the present embodiment, either the first and second lower electrodes 112a and 112b can be formed only on the lower surface of the lower substrate 110, or the first and second upper electrodes 122a and 122b can be formed only on the upper surface of the upper substrate 120.

A plurality of spacers 114 are formed between the lower and upper substrates 110 and 120 to maintain a particular gap therebetween. The spacers 114 are arranged parallel to one another in a direction perpendicular to the discharge electrodes 112a, 112b, 122a, and 122b. Each of the spacers 114 has a rectangular section in this embodiment. The spacers 114 are formed of a dielectric material, preferably, a transparent glass material, for example.

First and second auxiliary electrodes 140a and 140b are provided in each of the spacers 114 in a lengthwise direction of the spacers 114. The first and second auxiliary electrodes 140a and 140b are separated from each other in a horizontal direction. The first and second auxiliary electrodes 140a and 140b can be formed of for example at least one metal selected from a group consisting of silver (Ag), copper (Cu), and chrome (Cr), which are conductive materials. The first and second auxiliary electrodes 140a and 140b are floating electrodes in which a voltage is induced as a predetermined voltage is applied to the discharge electrodes 112a, 112b, 122a, and 122b. In the present embodiment, three or more auxiliary electrodes can be provided in each of the spacers 114.

A fluorescent layer 130 to generate visible light by being excited by ultraviolet rays that are generated by discharge is formed on the interior of the discharge space. That is, the fluorescent layer 130 is coated on an upper surface of the lower substrate 110, a lower surface of the upper substrate 120, and both side surfaces of each of the spacers 114, to a predetermined thickness.

In the flat lamp configured as above, when voltages, for example, 2000 V and 0 V, are applied to the first and second lower electrodes 112a and 112b, respectively, and voltages, for example, 2000 V and 0 V, are applied to the first and second upper electrodes 122a and 122b, respectively, a predetermined voltage less than 2000 V is induced to the first and second auxiliary electrodes 140a and 140b. Start discharges are generated by the induced voltage between the first and second auxiliary electrodes 140a and 140b and the second lower electrode 112b, and the first and second auxiliary electrodes 140a and 140b and the second upper electrode 122b. Accordingly, a discharge voltage can be lowered compared to the conventional flat lamp. After the start discharges are generated, sustain discharges are generated between the first and second lower electrodes 112a and 112b, and the first and second upper electrodes 122a and 122b.

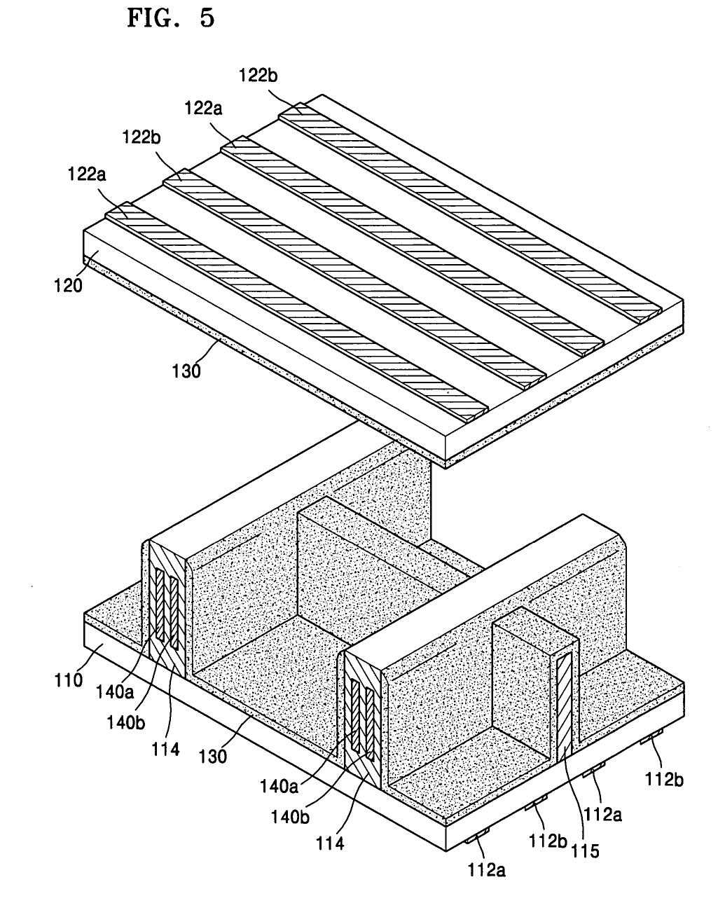

FIG. 5 shows a flat lamp according to another embodiment of the present invention. Referring to FIG. 5, a plurality of auxiliary spacers 115 are provided between the lower and upper substrates 110 and 120 parallel to one another in a direction perpendicular to the spacers 114. The height of the auxiliary spacers 115 is lower than that of the spacers 114. A fluorescent layer 130 is formed on the exterior of the auxiliary spacers 115, that is, both side surfaces and an upper surface of each of the auxiliary spacers 115. When the auxiliary spacers 115 are provided between the lower and upper substrates 110 and 120 and the fluorescent layer 130 is formed on the exterior of each of the auxiliary spacers 115, more amount of visible light can be generated than in the flat lamp shown in FIG. 2 so that a luminous efficiency is improved.

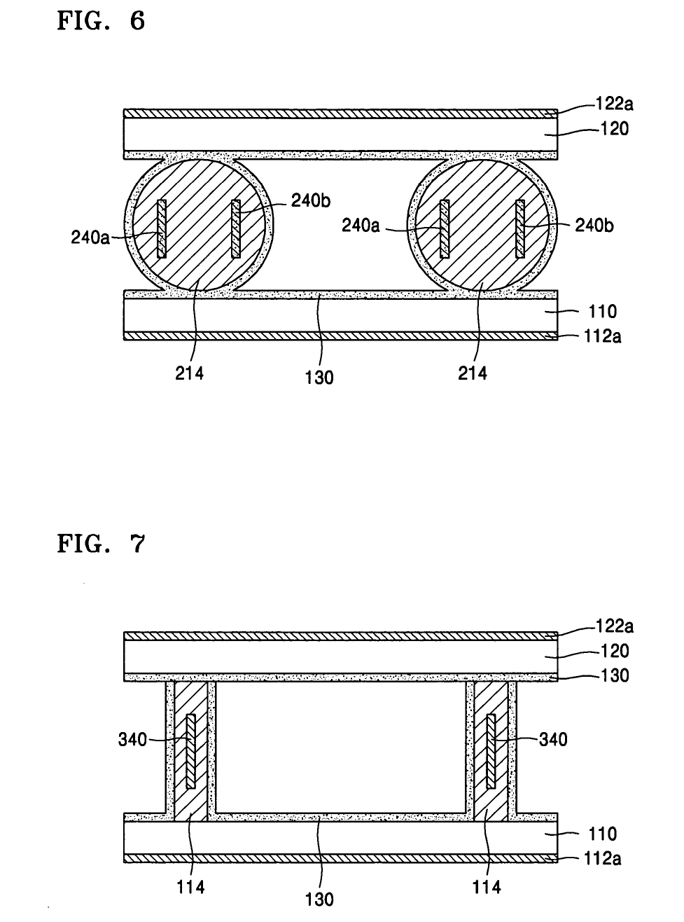

FIGS. 6 through 8 are cross-sectional views of flat lamps according to different embodiments of the present invention. Here, only the different portions from the above-described embodiments are described below.

In a flat lamp shown in FIG. 6, a plurality of spacers 214 having circular sections are provided between the lower and upper substrates 110 and 120. First and second auxiliary electrodes 240a and 240b, in which a voltage is induced by a voltage applied to the discharge electrodes (112a, 112b, 122a, and 122b of FIG. 2), are provided in each of the spacers 214. In the present embodiment, three or more auxiliary electrodes can be provided in each of the spacers 214. When the cylindrical spacers 214 are provided between the lower and upper substrates 110 and 120, more amount of the fluorescent layer 130 can be coated on the exterior of the spacers 214 so that a luminous efficiency of the lamp can be improved. Also, as a contact area between the spacers 214 and the upper substrate 120 decreases, more amount of visible light can be emitted through the upper substrate 120.

In a flat lamp shown in FIG. 7, a plurality of the spacers 114 is provided between the lower and upper substrates 110 and 120. One auxiliary electrode 340 in which a voltage is induced by a voltage applied to the discharge electrodes (112a, 112b, 122a, and 122b of FIG. 2) is provided in each of the spacers 114. In the present embodiment, each of the spacers 114 may be formed into a cylindrical shape.

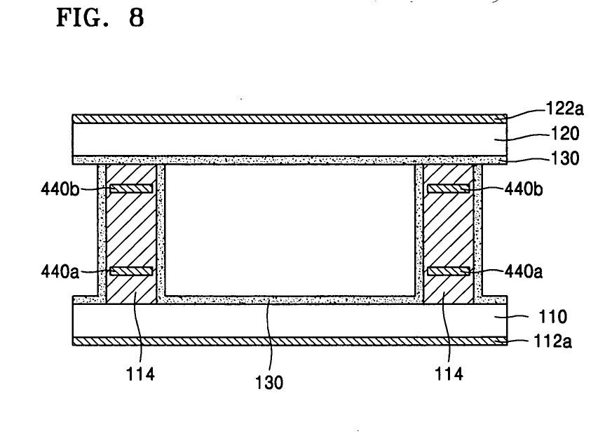

In a flat lamp shown in FIG. 8, a plurality of the spacers 114 is provided between the lower and upper substrates 110 and 120. First and second auxiliary electrode 440a and 440b in which a voltage is induced by a voltage applied to the discharge electrodes (112a, 112b, 122a, and 122b of FIG. 2) are provided in each of the spacers 114 in a vertical direction, that is, in the upper and lower portions of each spacer to be separated from each other. In the present embodiment, three or more auxiliary electrodes can be vertically provided and each of the spacers 114 may be formed into a cylindrical shape.

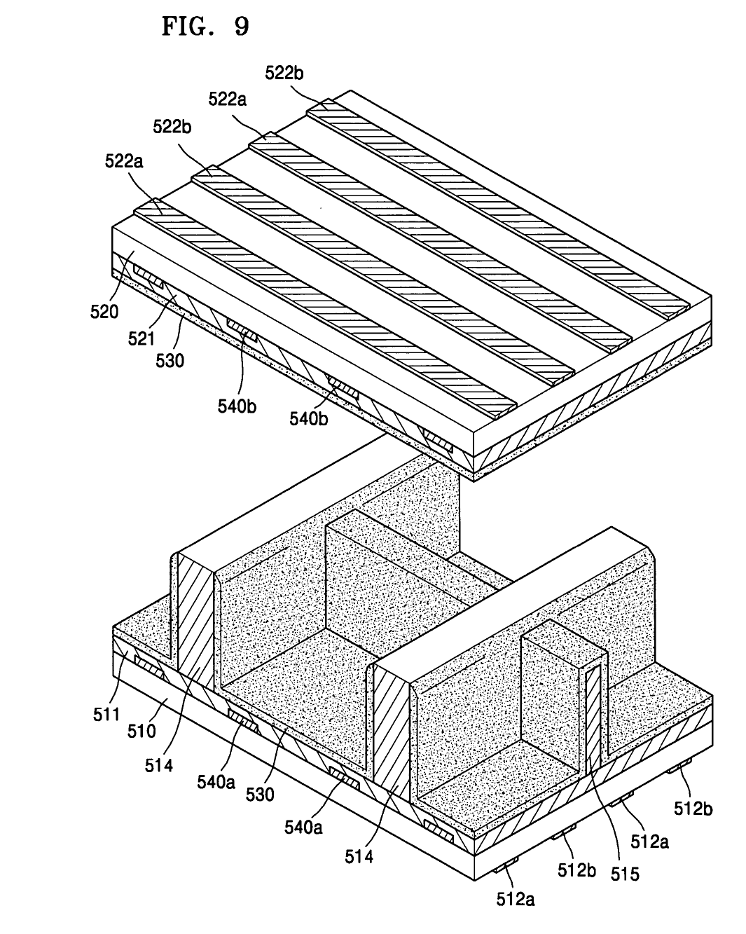

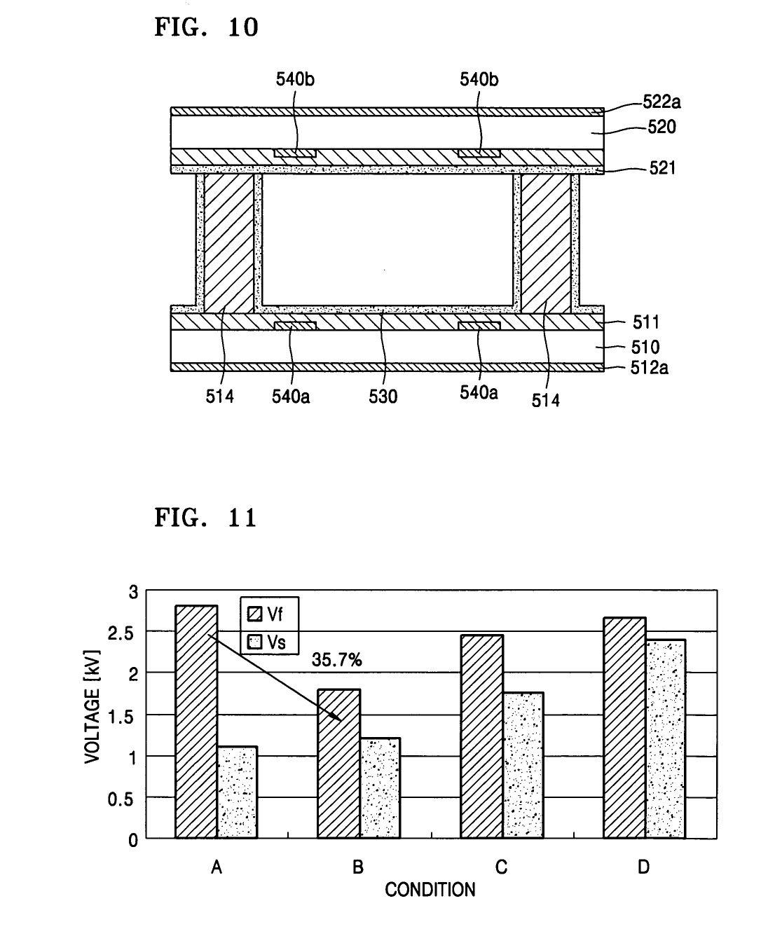

FIG. 9 is an exploded perspective view illustrating a portion of a flat lamp according to another embodiment of the present invention. FIG. 10 is a cross-sectional view of the flat lamp of FIG. 9.

Referring to FIGS. 9 and 10, a lower substrate 510 and an upper substrate 520 are separated from each other to face each other and a discharge space is formed therebetween. First and second lower electrodes 512a and 512b, which are discharge electrodes, are formed on a lower surface of the lower substrate 510 in pairs and in strips parallel to each other. First and second upper electrodes 522a and 522b, which are discharge electrodes, are formed in pairs on an upper surface of the upper substrate 520 in a direction parallel to the first and second lower electrodes 512a and 512b. In the present embodiment, either the first and second lower electrodes the first and second lower electrodes 512a and 512b can be formed only on the lower surface of the lower substrate 510, or the first and second upper electrodes 522a and 522b can be formed only on the upper surface of the upper substrate 520.

A plurality of spacers 514 to maintain a particular gap between the lower and upper substrates 510 and 520 is provided therebetween. The spacers 514 are arranged parallel to one another in a direction perpendicular to the discharge electrodes 512a, 512b, 522a, and 522b. Alternatively, the spacers 514 may be arranged parallel to the discharge electrodes 512a, 512b, 522a, and 522b. Each of the spacers 514 is formed of a transparent glass material. In the present embodiment, a circular spacer can be provided.

A plurality of auxiliary spacers 515 is provided between the lower and upper substrates 510 and 520 in a direction perpendicular to the spacers 514. The height of the auxiliary spacers 515 is lower than that of the spacers 514.

A plurality of first auxiliary electrodes 540a is formed on the upper surface of the lower substrate 510 parallel to one another in a direction perpendicular to the first and second lower electrodes 512a and 512b. A plurality of second auxiliary electrodes 540b is formed on the lower surface of the upper substrate 520 parallel to one another in a direction perpendicular to the first and second upper electrodes 522a and 522b. The first and second auxiliary electrodes 540a and 540b can be formed of at least one metal selected from a group consisting of silver (Ag), copper (Cu), and chrome (Cr), which are conductive materials. The first and second auxiliary electrodes 540a and 540b are floating electrodes in which a voltage is induced as a predetermined voltage is applied to each of the first and second lower electrodes 512a and 512b and the first and second upper electrodes 522a and 522b.

A first dielectric layer 511 having a predetermined thickness is formed on the upper surface of the lower substrate 510 to cover the first auxiliary electrodes 540a. A second dielectric layer 521 having a predetermined thickness is formed on the lower surface of the upper substrate 520 to cover the second auxiliary electrodes 540b.

A fluorescent layer 530 is formed on the upper surface of the first dielectric layer 511, the lower surface of the second dielectric layer 521, and both side surfaces of each of the spacers 514, which constitute the interior of the discharge space in this embodiment. Also, the fluorescent layer 530 is formed on both side surfaces and the upper surface of each of the auxiliary spacers 515.

In the flat lamp configured as above, when voltages, for example, 2000 V and 0V, are applied to the first and second lower electrodes 512a and 512b, respectively, and voltages, for example, 2000 V and 0 V, are applied to the first and second upper electrodes 522a and 522b, respectively, a predetermined voltage less than 2000 V is induced to the first and second auxiliary electrodes 540a and 540b. Start discharges are generated by the induced voltage between the first auxiliary electrode 540a and the second lower electrode 512b, and the second auxiliary electrode 540b and the second upper electrode 522b. Accordingly, a discharge voltage can be lowered compared to the conventional flat lamp. After the start discharges are generated, sustain discharges are generated between the first and second lower electrodes 512a and 512b, and the first and second upper electrodes 522a and 522b.

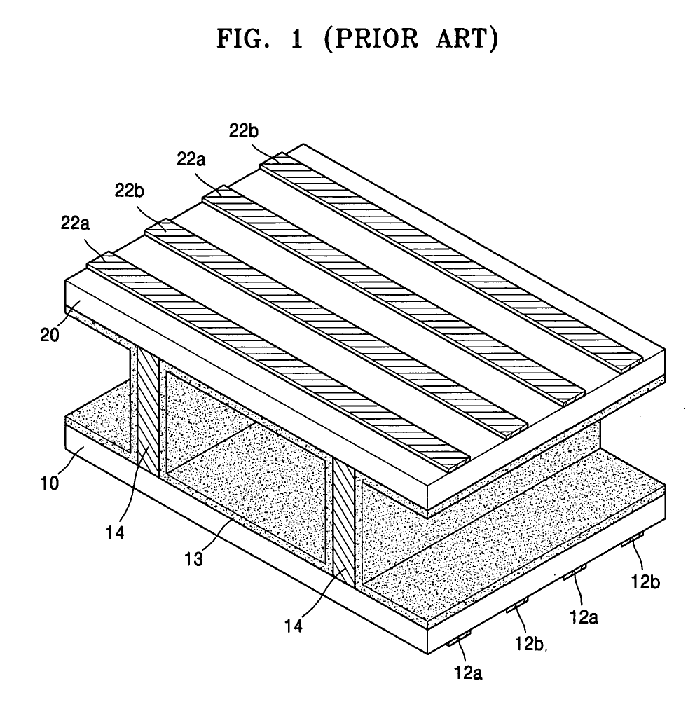

FIG. 11 is a graph showing the result of comparison in the discharge voltage between the conventional flat lamp shown in FIG. 1 and the flat lamp according to the present invention shown in FIG. 2. In FIG. 11, “A” denotes a discharge start voltage Vf and a discharge sustain voltage Vs of the conventional flat lamp when the pressure of the discharge gas is 40 Torr while “B”, “C”, and “D” denote the discharge start voltage Vf and the discharge sustain voltage Vs of the flat lamp according to the present invention when the pressure of the discharge gas is 40 Torr, 100 Torr, and 150 Torr, respectively. In FIG. 11, the compositions of the discharge gas for the cases of A, B, C, and D are all the same as Ne—Xe 50%. Referring to FIG. 11, when the pressure of the discharge gas is 40 Torr, it can be seen that the discharge start voltage Vf of the flat lamp according to this embodiment of the present invention is reduced by about 35.7% compared to the conventional flat lamp.

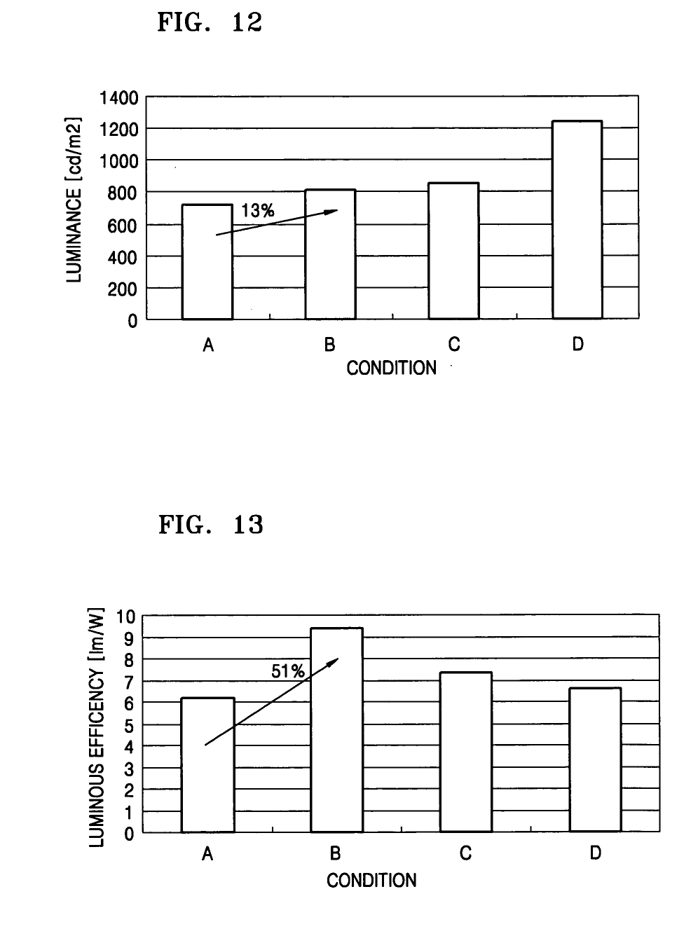

FIG. 12 is a graph showing the result of comparison in the luminance between the conventional flat lamp shown in FIG. 1 and the flat lamp according to the present invention shown in FIG. 2. FIG. 13 is a graph showing the result of comparison in the luminous efficiency between the conventional flat lamp shown in FIG. 1 and the flat lamp according to the present invention shown in FIG. 2.

In FIGS. 12 and 13, “A” denotes the luminance and luminous efficiency of the conventional flat lamp when the pressure of the discharge gas is 40 Torr and the discharge sustain voltage is 2 kV while “B”, “C”, and “D” denote the luminance and luminous efficiency of the flat lamp according to the present invention when the pressure of the discharge gas is 40 Torr, 100 Torr, and 150 Torr, respectively, and the discharge sustain voltages are 2 kV, 2 kV, and 2.6 kV, respectively. In FIGS. 12 and 13, the compositions of the discharge gas are all the same as Ne—Xe 50%. Referring to FIGS. 12 and 13, it can be seen that, at the same composition of the discharge gas and the discharge sustain voltage, the luminance and luminous efficiency of this embodiment of the flat lamp according to the present invention are improved by about 13% and 51%, respectively, compared to the conventional flat lamp.

As described above, according to the flat lamp according to the present invention, since the auxiliary electrodes in which a voltage is induced as a voltage is applied to the discharge electrodes are provided in each of the spacers, the discharge voltage can be lowered. Accordingly, since the partial pressure of the xenon gas and the pressure of the discharge gas are increased, the luminous efficiency can be improved.

While this invention has been particularly shown and described with reference to preferred embodiments thereof, it will be understood by those skilled in the art that various changes in form and details may be made therein without departing from the spirit and scope of the invention as defined by the appended claims.

1. A flat lamp comprising:
a lower substrate and an upper substrate arranged to face each other and forming a discharge space between the lower substrate and the upper substrate;
a plurality of discharge electrodes formed at least one of the lower substrate and the upper substrate;
a plurality of spacers provided between the lower substrate and the upper substrate to maintain a uniform gap between the lower substrate and the upper substrate;
at least one auxiliary electrode provided in each of the spacers, in which a voltage is induced as a voltage is applied to the discharge electrodes; and
a fluorescent layer formed on an interior of the discharge space.

2. The flat lamp as claimed in claim 1, wherein the discharge electrodes are formed on an outer surface of at least one of the lower substrate and the upper substrate.

3. The flat lamp as claimed in claim 1, wherein the spacers are provided in a direction perpendicular to the discharge electrodes.

4. The flat lamp as claimed in claim 1, wherein the spacers have rectangular sections.

5. The flat lamp as claimed in claim 1, wherein the spacers have circular sections.

6. The flat lamp as claimed in claim 1, wherein the spacers are formed of a dielectric material.

7. The flat lamp as claimed in claim 6, wherein the spacers are formed of a transparent glass material.

8. The flat lamp as claimed in claim 1, wherein two auxiliary electrodes are provided in each of the spacers in a lengthwise direction of the spacers.

9. The flat lamp as claimed in claim 9, wherein the two auxiliary electrodes are separated from each other in a horizontal direction.

10. The flat lamp as claimed in claim 8, wherein the two auxiliary electrodes are separated from each other in a vertical direction.

11. The flat lamp as claimed in claim 1, wherein the auxiliary electrode is formed of metal.

12. The flat lamp as claimed in claim 1, wherein the auxiliary electrode is formed of at least one selected from a group consisting of silver (Ag), copper (Cu), and chrome (Cr).

13. The flat lamp as claimed in claim 1, wherein a plurality of auxiliary spacers is provided between the lower substrate and the upper substrate in a direction perpendicular to the spacers.

14. The flat lamp as claimed in claim 13, wherein the height of the auxiliary spacers is less than that of the spacers.

15. The flat lamp as claimed in claim 13, wherein the fluorescent layer is formed on an exterior of each of the auxiliary spacers.

16. The flat lamp as claimed in claim 1, wherein the discharge space is filled with a discharge gas that is a mixture of neon (Ne) gas and xenon (Xe) gas.

17. A flat lamp comprising:
a lower substrate and an upper substrate arranged to face each other and forming a discharge space between the lower substrate and the upper substrate;
a plurality of discharge electrodes formed at least one of the lower substrate and the upper substrate;
a plurality of spacers provided between the lower substrate and the upper substrate to maintain a uniform gap between the lower substrate and the upper substrate;
a plurality of auxiliary electrodes provided formed at least one of the lower substrate and the upper substrate, in which a voltage is induced as a voltage is applied to the discharge electrodes; and
a fluorescent layer formed on an interior of the discharge space.

18. The flat lamp as claimed in claim 17, wherein the discharge electrodes are formed on an outer surface of at least one of the lower substrate and the upper substrate.

19. The flat lamp as claimed in claim 17, wherein the auxiliary electrodes are formed in a direction perpendicular to the discharge electrodes.

20. The flat lamp as claimed in claim 17, wherein the auxiliary electrodes are formed on an inner surface of at least one of the lower substrate and the upper substrate.

21. The flat lamp as claimed in claim 20, wherein a dielectric layer is formed on an inner surface of at least one of the lower substrate and the upper substrate where the auxiliary electrodes are provided, to cover the auxiliary electrodes.

22. The flat lamp as claimed in claim 17, wherein the auxiliary electrodes are formed of a transparent conductive material.

23. The flat lamp as claimed in claim 22, wherein the auxiliary electrodes are formed of ITO (indium tin oxide).

24. The flat lamp as claimed in claim 17, wherein the auxiliary electrodes are formed of at least one selected from a group consisting of silver (Ag), copper (Cu), and chrome (Cr).

25. The flat lamp as claimed in claim 17, wherein the spacers are provided in a direction perpendicular to the discharge electrodes.

26. The flat lamp as claimed in claim 17, wherein the spacers have rectangular sections.

27. The flat lamp as claimed in claim 17, wherein the spacers have circular sections.

28. The flat lamp as claimed in claim 17, wherein a plurality of auxiliary spacers is provided between the lower substrate and the upper substrate in a direction perpendicular to the spacers.

29. The flat lamp as claimed in claim 28, wherein the height of the auxiliary spacers is less than that of the spacers.

30. The flat lamp as claimed in claim 28, wherein the fluorescent layer is formed on an exterior of each of the auxiliary spacers.

31. The flat lamp as claimed in claim 17, wherein the discharge space is filled with a discharge gas that is a mixture of neon (Ne) gas and xenon (Xe) gas.
